(19) United States
(12) Patent Application Publication
(10) Pub. No.: US 2024/0088618 A1
(43) Pub. Date: Mar. 14, 2024

(54) Bump-Crimping Device

(71) Applicant: Thomas Armstrong, Akron, OH (US)

(72) Inventor: Thomas Armstrong, Akron, OH (US)

(21) Appl. No.: 18/466,884

(22) Filed: Sep. 14, 2023

Related U.S. Application Data
(60) Provisional application No. 63/406,305, filed on Sep. 14, 2022.

(51) Int. Cl. H01R 43/042

(52) U.S. Cl. CPC H01R 43/0427

(57) ABSTRACT

A bump-crimping device is provided. The device is comprised of a body that receives at least one punch and at least one cable end. The cable end rests within a receiving area that holds the end in place while the punch, which is attached to and powered by an air hammer or impact gun, is pressed down on the end to crimp the end. The body may also be comprised of a handle to allow a user to securely hold the device during use.

### CROSS-REFERENCE TO RELATED APPLICATION

The present application claims priority to, and the benefit of, U.S. Provisional Application No. 63/406,305, which was filed on Sep. 14, 2022, and is incorporated herein by reference in its entirety.

### FIELD OF THE INVENTION

The present invention relates generally to the field of cable crimping. More specifically, the present invention relates to a bump-crimping device that can be used in conjunction with an air hammer or impact gun to easily crimp a cable inserted into the device. Accordingly, the present disclosure makes specific reference thereto. Nonetheless, it is to be appreciated that aspects of the present invention are also equally applicable to other like applications, devices, and methods of manufacture.

### BACKGROUND

The process of crimping in the electrical industry, specifically in battery connections, often takes longer than it ideally should. This is due to the lack of accessible space for the mechanics to work. This is a challenge that many mechanics face, especially when dealing with vehicles or machinery with compact designs and tight quarters. These constraints make it difficult for them to use conventional crimping tools, which are often bulky and unwieldy, leading to suboptimal outcomes. In particular, the connections made to the batteries may be compromised or ruined altogether as a result of using these ill-suited tools.

In some instances, individuals may have to replace entire sections of battery cable because the location of the bad spot is simply not accessible with standard crimping devices. The lack of proper tools can make it nearly impossible for mechanics to reach and properly fix certain connections, which ultimately leads to unnecessary expenses and inconvenience for the customers.

Moreover, even when a mechanic does manage to attempt a crimp in a tight space, they often struggle to ensure that the connection inside the crimp is solid. Without the proper space and tools to work with, the crimp may be too loose, too tight, or otherwise flawed, resulting in a weak or unstable connection. If left unchecked, these faulty connections can lead to connection failures, electrical shorts, and other potentially dangerous situations. In essence, the lack of appropriate tools and the spatial limitations faced by mechanics in crimping battery connections can pose significant challenges and risks for both mechanics and their customers.

Therefore, there exists a long-felt need in the art for an improved crimping tool. There also exists a long-felt need in the art for a bump-crimping device. More specifically, there exists a long-felt need in the art for a bump-crimping device that can be used to crimp cable in tight spaces. Further, there exists a long-felt need in the art for a bump-crimping device that can be used to crimp cable quickly and efficiently. In addition, there exists a long-felt need in the art for a bump-crimping device that can be used to crimp cable quickly and efficiently without requiring significant physical exertion from the user.

The subject matter disclosed and claimed herein, in one embodiment thereof, comprises a bump-crimping device. The device is comprised of a body that receives at least one punch and at least one cable end. The cable end rests within a receiving area that holds the end in place while the punch, which is attached to and powered by an air hammer or impact gun, is pressed down on the end to crimp the end. The body may also be comprised of a handle to allow a user to securely hold the device during use.

In this manner, the bump-crimping device of the present invention accomplishes all the forgoing objectives and provides an improved crimping tool. More specifically, the device can be used to crimp cable in tight spaces quickly and efficiently. While doing so, the device does not require significant physical exertion from the user due to the usage of an air hammer or impact gun.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a bump-crimping device primarily comprised of a body having a receiving area for an end of a battery cable, and at least one punch that passes through at least one opening of the body. The device allows a user to easily crimp the end of a battery cable using an air hammer or impact gun and the device.

The body of the device is preferably rectangular in shape. In order to allow the body to be held during use, the body may be comprised of at least one handle. The handle may be fixedly attached to the body in one embodiment. In another embodiment, the handle may removably attach to the body.

The body receives at least one punch. More specifically, the body is comprised of at least one opening that allows the punch to be positioned through the body such that the second end of the punch contacts a receiving area within the body. The receiving area is preferably V-shaped and has an angled first edge and a second edge. The area receives the end of a battery cable that is inserted into the body to keep the end in place as the second end of the punch impacts the end to crimp the end.

The first end of the punch can be attached to at least one chuck of an air hammer or impact gun. In this manner, the air hammer or impact gun can be used to drive the punch downwards and into the receiving area. In this manner, the impact from the punch onto the end crimps the end. After crimping, the cable can be removed from the body.

The present invention is also comprised of a method of using the device. First, a device is provided comprised of a body comprised of at least one opening, at least one punch, and at least one receiving area. Then, a user can insert the end of a battery cable (or another cable of the like) into the body such that the end rests within the receiving area. Then, the first end of the punch can be inserted into the chuck of an air hammer or impact gun. Next, the punch can be inserted into the opening. Then, a user can grasp a handle of the body. Then, the air hammer or impact gun can be fired to drive the punch downward towards the receiving area, which results in the second end of the punch striking the end to crimp the end. Finally, the cable can be removed from the area and body.

In a second method of using the device, the device is comprised of a body comprised of at least one opening, at least one punch, and at least one receiving area. Then, a user can insert the end of a battery cable (or another cable of the like) into the body such that the end rests within the receiving area. Then, the first end of the punch can be inserted into the chuck of an air hammer or impact gun and the punch can be inserted into the opening. Then, a user can attach a handle to the body via at least one fastener of the handle and/or body and grasp a handle while the air hammer or impact gun can be fired to drive the punch downward toward the receiving area. This results in the second end of the punch striking the end to crimp the end. Finally, the cable can be removed from the area and body.

Accordingly, the bump-crimping device of the present invention is particularly advantageous as it provides an improved crimping tool. More specifically, the device can be used to crimp cable in tight spaces quickly and efficiently. While doing so, the device does not require significant physical exertion from the user due to the usage of an air hammer or impact gun. In this manner, the bump-crimping device overcomes the limitations of existing methods and devices used to crimp cables known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a bump-crimping device of the present invention in accordance with the disclosed architecture;

FIG. 2 illustrates a perspective view of one potential embodiment of a bump-crimping device of the present invention while a cable is inserted into a body of the device in accordance with the disclosed architecture;

FIG. 3 illustrates a flowchart of a method of using one potential embodiment of a bump-crimping device of the present invention in accordance with the disclosed architecture; and

FIG. 4 illustrates a flowchart of a method of using one potential embodiment of a bump-crimping device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved crimping tool. There also exists a long-felt need in the art for a bump-crimping device. More specifically, there exists a long-felt need in the art for a bump-crimping device that can be used to crimp cable in tight spaces. Further, there exists a long-felt need in the art for a bump-crimping device that can be used to crimp cable quickly and efficiently. In addition, there exists a long-felt need in the art for a bump-crimping device that can be used to crimp cable quickly and efficiently without requiring significant physical exertion from the user.

The present invention, in one exemplary embodiment, is comprised of a bump-crimping device. The device is primarily comprised of a body having a receiving area for an end of a battery cable, and at least one punch that passes through at least one opening of the body. The device allows a user to easily crimp the end of a battery cable using an air hammer or impact gun and the device.

The body of the device is preferably rectangular in shape and may be comprised of at least one handle. The handle may be fixedly attached to the body in one embodiment. In another embodiment, the handle may removably attach to the body.

The body receives at least one punch. More specifically, the body is comprised of at least one opening that allows the punch to be positioned through the body such that the second end of the punch contacts a receiving area within the body. The receiving area is preferably V-shaped and has an angled first edge and a second edge and receives the end of a battery cable that is inserted into the body to keep the end in place as the second end of the punch impacts the end to crimp the end.

The first end of the punch can be attached to at least one chuck of an air hammer or impact gun. In this manner, the air hammer or impact gun can be used to drive the punch downwards and into the receiving area. In this manner, the impact from the punch onto the end crimps the end. After crimping, the cable can be removed from the body.

The present invention is also comprised of a method of using the device. First, a device is provided comprised of a body comprised of at least one opening, at least one punch, and at least one receiving area. Then, a user can insert the end of a battery cable (or another cable of the like) into the body such that the end rests within the receiving area. Then, the first end of the punch can be inserted into the chuck of an air hammer or impact gun. Next, the punch can be inserted into the opening. Then, a user can grasp a handle of the body. Then, the air hammer or impact gun can be fired to drive the punch downward towards the receiving area, which results in the second end of the punch striking the end to crimp the end. Finally, the cable can be removed from the area and body.

In a second method of using the device, the device is comprised of a body comprised of at least one opening, at least one punch, and at least one receiving area. Then, a user can insert the end of a battery cable (or another cable of the like) into the body such that the end rests within the receiving area. Then, the first end of the punch can be inserted into the chuck of an air hammer or impact gun and the punch can be inserted into the opening. Then, a user can attach a handle to the body via at least one fastener of the handle and/or body and grasp a handle while the air hammer or impact gun can be fired to drive the punch downward toward the receiving area. This results in the second end of the punch striking the end to crimp the end. Finally, the cable can be removed from the area and body.

Accordingly, the bump-crimping device of the present invention is particularly advantageous as it provides an improved crimping tool. More specifically, the device can be used to crimp cable in tight spaces quickly and efficiently. While doing so, the device does not require significant physical exertion from the user due to the usage of an air hammer or impact gun. In this manner, the bump-crimping device overcomes the limitations of existing methods and devices used to crimp cables known in the art.

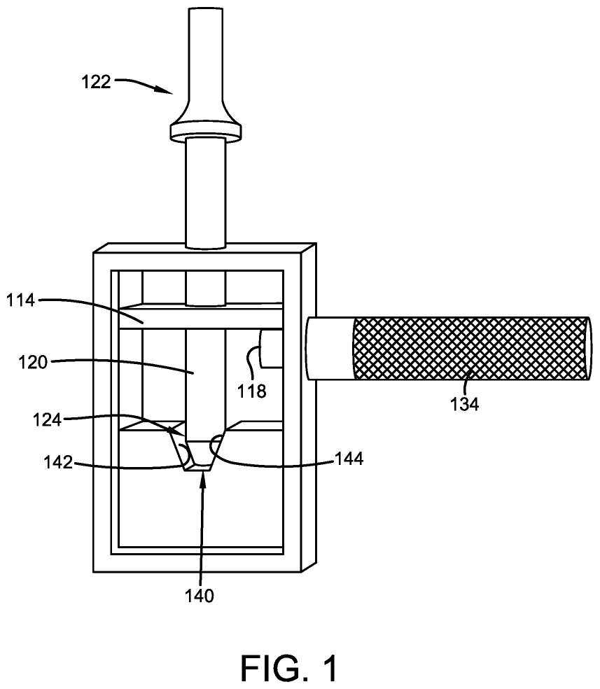

Referring initially to the drawings, FIG. 1 illustrates a front view of one potential embodiment of a bump-crimping device 100 of the present invention in accordance with the disclosed architecture. The device 100 is primarily comprised of a body 110 having a receiving area 140 for an end 22 of a battery cable 20, and at least one punch 120 that passes through at least one opening 112 of the body 110. The device 100 allows a user to easily crimp the end 22 of a battery cable 20 using an air hammer or impact gun and the device 100.

The body 110 of the device 100 is preferably rectangular in shape. However, the body 110 may be any shape in different embodiments. The body 110 is preferably made from a durable metal or plastic material. In order to allow the body 110 to be held during use, the body 110 may be comprised of at least one handle 130. The handle 130 may be fixedly attached to the body 110 in one embodiment. In another embodiment, the handle 130 may removably attach to the body 110. In this embodiment, the handle 130 may be comprised of at least one fastener 132 that may engage at least one fastener 118 of the body 110. The fasteners 118, 132 may be any reciprocating fastener type such as but not limited to male and female, nut and bolt, tongue and groove, etc.

The handle 130 may also be comprised of at least one grip area 134. The area 134 may be comprised of a raised or recessed texture to improve grip. The grip area 134 may be integrally formed to the handle 130 in one embodiment (ex. knurling) or may be a rubber (or other similar non-slip material) that is applied around the handle 130.

The body 110 receives at least one punch 120. More specifically, the body 110 is comprised of at least one opening 112 that allows the punch 120 to be positioned through the body 110 such that the second end 124 of the punch 120 contacts a receiving area 140 within the body 110. The end 124 may be comprised of a rounded tip, or any tip shape in different embodiments. In one embodiment, the body 110 may also be comprised of at least one support member 114 that provides horizontal structural support to the body 110. The member 114 may also be comprised of at least one opening 116 that the punch 120 passes through. In this manner, the member 114 further aligns the punch 120 within the body 110.

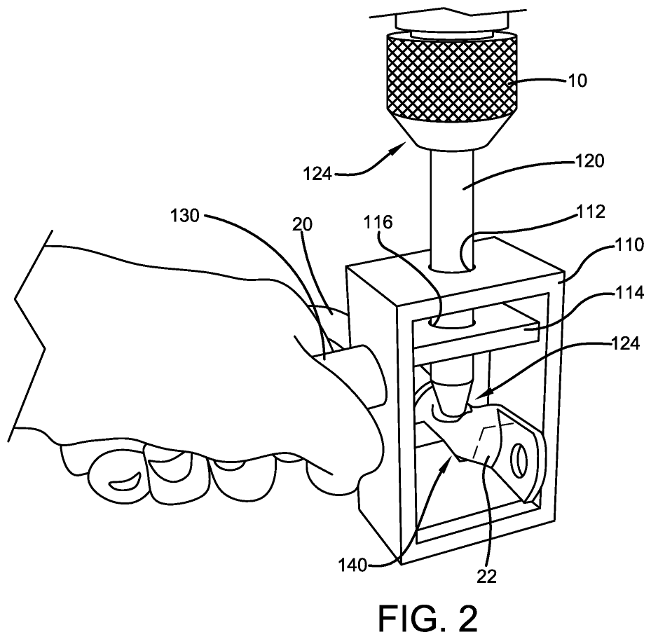

The receiving area 140 is preferably V-shaped and has an angled first edge 142 and second edge 144. The edges 142, 144 may form any angle less than 180 degrees. The area 140 receives the end 22 of a battery cable 20 that is inserted into the body 110. More specifically, the area 140 keeps the end 22 in place as the second end 124 of the punch 120 impacts the end 22 to crimp the end 124, as seen in FIG. 2. Both openings 112, 116 align with the receiving area 140 to ensure adequate positioning of the punch 120 above said area 140.

The first end 122 of the punch 120 can be attached to at least one chuck 10 of an air hammer or impact gun. In this manner, the air hammer or impact gun can be used to drive the punch 120 downwards and into the receiving area 140. In this manner, the impact from the punch 120 onto the end 22 crimps the end 22. After crimping, the cable 20 can be removed from the body 110.

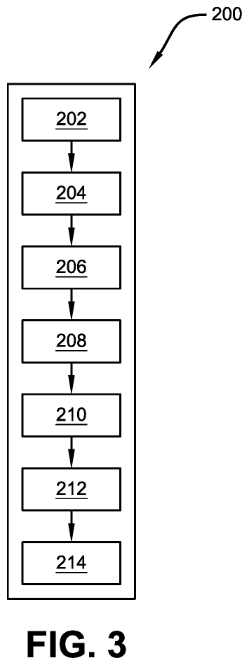

The present invention is also comprised of a method of using 200 the device 100, as seen in FIG. 3. First, a device 100 is provided comprised of a body 110 comprised of at least one opening 112, at least one punch 120, and at least one receiving area 140 [Step 202]. Then, a user can insert the end 22 of a battery cable 20 (or another cable of the like) into the body 110 such that the end 22 rests within the receiving area 140 [Step 204]. Then, the first end 122 of the punch 120 can be inserted into the chuck 10 of an air hammer or impact gun [Step 206]. Next, the punch 120 can be inserted into the opening 112 [Step 208]. Then, a user can grasp a handle 130 of the body 110 [Step 210]. Then, the air hammer or impact gun can be fired to drive the punch 120 downward toward the receiving area 140, which results in the second end 124 of the punch 120 striking the end 22 to crimp the end 22 [Step 212]. Finally, the cable 20 can be removed from the area 140 and body 110 [Step 214].

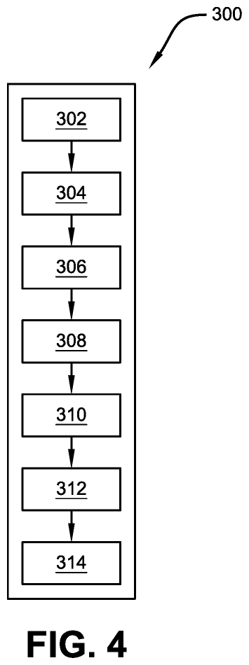

A second method of using 300 the device 100 (as seen in FIG. 4) involves providing a device 100 comprised of a body 110 comprised of at least one opening 112, at least one punch 120, and at least one receiving area 140 [Step 302]. Then, a user can insert the end 22 of a battery cable 20 (or another cable of the like) into the body 110 such that the end 22 rests within the receiving area 140 [Step 304]. Then, the first end 122 of the punch 120 can be inserted into the chuck 10 of an air hammer or impact gun [Step 306]. Next, the punch 120 can be inserted into the opening 112 [Step 308]. Then, a user can attach a handle 130 to the body 110 via at least one fastener 118, 132 of the handle 130 and/or body 110 and grasp a handle 130 [Step 310]. Then, the air hammer or impact gun can be fired to drive the punch 120 downward toward the receiving area 140, which results in the second end 124 of the punch 120 striking the end 22 to crimp the end 22 [Step 312]. Finally, the cable 20 can be removed from the area 140 and body 110 [Step 314].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “bump-crimping device” and “device” are interchangeable and refer to the bump-crimping device 100 of the present invention.

Notwithstanding the forgoing, the bump-crimping device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the bump-crimping device 100 as shown in the FIGS. are for illustrative purposes only, and that many other sizes and shapes of the bump-crimping device 100 are well within the scope of the present disclosure. Although the dimensions of the bump-crimping device 100 are important design parameters for user convenience, the bump-crimping device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A bump-crimping device comprising:
a body comprised of an opening and a receiving area; and
a punch positioned within the body via the opening, wherein the opening aligns with the receiving area.

2. The bump-crimping device of claim 1, wherein the receiving area forms an acute angle.

3. The bump-crimping device of claim 1, wherein a second end of the punch is comprised of a rounded tip.

4. The bump-crimping device of claim 1, wherein the body is comprised of a rectangular shape.

5. The bump-crimping device of claim 1, wherein the body is comprised of a metal.

6. The bump-crimping device of claim 1, wherein the body is comprised of a plastic.

7. A bump-crimping device comprising:
a body comprised of a first opening, a receiving area, and a handle; and
a punch positioned within the body via the first opening, wherein the first opening aligns with the receiving area.

8. The bump-crimping device of claim 7, wherein the body is comprised of a support member.

9. The bump-crimping device of claim 8, wherein the support member is comprised of a second opening.

10. The bump-crimping device of claim 9, wherein the second opening aligns with the first opening.

11. The bump-crimping device of claim 10, wherein the second opening aligns with the receiving area.

12. The bump-crimping device of claim 9, wherein the handle is comprised of a grip area.

13. The bump-crimping device of claim 12, wherein the grip area is comprised of a raised texture.

14. The bump-crimping device of claim 12, wherein the grip area is comprised of a recessed texture.

15. The bump-crimping device of claim 12, wherein the grip area is comprised of a rubber material.

16. The bump-crimping device of claim 9, wherein the handle removably attaches to the body.

17. The bump-crimping device of claim 9, wherein the receiving area is comprised of a first edge and a second edge.

18. The bump-crimping device of claim 17, wherein the first edge and the second edge form an angle less than 180 degrees.

19. A method of using a bump-crimping device, the method comprising the following steps:
providing a bump-crimping device comprised of a body comprised of a first opening and a receiving area, and a punch;
inserting an end of a battery cable into the body such that the end of the battery cable rests within the receiving area;
inserting a first end of the punch into a chuck of an air hammer or impact gun;
inserted the punch into the opening; and
firing the air hammer or impact gun to drive the punch downwards into the end of the cable to crimp the end against the receiving area.

20. The method of using a bump-crimping device of claim 19 further comprised of a step of grasping a handle of the body.
